(19) United States
(12) Patent Application Publication
(10) Pub. No.: US 2017/0039887 A1
(43) Pub. Date: Feb. 9, 2017

(54) SYSTEMS AND COMPUTERIZED-METHODS FOR ASSISTING A USER IN DETERMINING GEOMETRIC PROOFS

(71) Applicant: CanFigurelt LLC, New York, NY (US)

(72) Inventors: Eyal Inbar, Tel Aviv (IL); Arnon Avitzur, New York, NY (US)

(21) Appl. No.: 15/094,403

(22) Filed: Apr. 8, 2016

Related U.S. Application Data
(60) Provisional application No. 62/145,898, filed on Apr. 10, 2015.

(51) Int. Cl. G09B 19/02; G09B 5/02

(52) U.S. Cl. CPC G09B 19/025; G09B 5/02

(57) ABSTRACT

Methods for assisting a user in determining geometrical proofs are provided. A geometrical object with a corresponding predicate to be justified and one or more known predicates are presented to a user. The user can select one or more known predicates and corresponding derivations that justify the known predicate and can justify the predicate to be justified.

### CROSS REFERENCE TO RELATED APPLICATIONS

This application claims the benefit of and priority to U.S. Provisional Patent Application Ser. No. 62/145,898, filed on Apr. 10, 2015, the entire contents of which are incorporated herein by reference in its entirety.

### FIELD OF THE INVENTION

The invention relates generally to assisting a user in determining geometric proofs. More specifically, a user can be provided a predicate (e.g., claim) to be proofed regarding a geometrical object and corresponding derivations (e.g., theorems) related to the object that can be used to justify the claim.

### BACKGROUND

Current systems that allow for geometric solving exist. These systems typically translate geometrical theories into software models. For example, current systems can allow a user to select/create geometrical figures and then automatically present the user with corresponding claims regarding the figures and proofs. However, these current systems do not offer interaction with the user while performing the proofs. Therefore, the current systems lack the ability for a user to be involved in the proofing process.

Other difficulties with the current systems are that they do not allow a user to appreciate the many ways a geometrical figure can be proved, they provide the user an answer without the user having to do any analysis, and do not provide the user with any insight into constructing their own proofs.

Therefore, it can be desirable to provide a user interactive geometric solving system that allows a user to solve the geometrical figure with a number of approaches that depends on the number of theorems and derivations that exist. It can also be desirable to provide a user with an interactive approach to geometric solving that requires mental attention of the user such that the probability that the user remembers the proof is high.

### SUMMARY OF EMBODIMENTS OF THE INVENTION

In one aspect, the invention involves a computerized-method for assisting a user in determining geometrical proofs. The method also involves providing a geometrical object, a corresponding a predicate to be justified, and one or more known predicates regarding the geometrical object. The method also involves receiving a selection of one predicate of the one or more known predicates. The method also involves displaying a plurality of derivations corresponding to the selected known predicate and receiving a selection of one derivation of the plurality of derivations. The method also involves displaying a user input template corresponding to the derivation and receiving derivation input via the user template. The method also involves determining whether the derivation input is correct and if the derivation input is correct, then adding a resulting predicate to the plurality of known predicates and transmitting the resulting predicate to the display. The method also involves determining whether the resulting predicate is the predicate to be justified and if the resulting predicate is not the predicate to be justified, then repeating steps b) through i).

In some embodiments, the method also involves if the derivation input is not correct transmitting an error indicator to the display. In some embodiments, the method also involves displaying a hint for correcting the derivation input.

In some embodiments, the method also involves receiving a second claim to be justified regarding the geometrical object, and repeating steps above. In some embodiments, transmitting the derivation to the display includes transmitting a corresponding derivation description to the display. In some embodiments, determining whether the derivation input is correct further comprises comparing the derivation input to the plurality of known predicates based on geometrical principals.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 is a diagram of an exemplary system for assisting users in a geometric proof, according to an illustrative embodiment of the invention.

FIG. 2 is a flow diagram illustrating a method for assisting users in a geometric proof, according to an illustrative embodiment of the invention.

FIG. 3 is an exemplary interface for displaying a geometrical problem, according to an illustrative embodiment of the invention.

FIG. 4 is an exemplary interface for providing a geometrical object, a predicate to be proved, and one or more known predicates, according to an illustrative embodiment of the invention.

FIG. 5 is the exemplary interface showing the predicate to be proved highlighted on the geometrical object, according to an illustrative embodiment of the invention.

FIG. 6 is the exemplary interface showing one known predicate of the one or more known predicates highlighted on the geometrical object, according to an illustrative embodiment of the invention.

FIG. 7 is the exemplary interface showing one known predicate of the one or more known predicates highlighted on the geometrical object, according to an illustrative embodiment of the invention.

FIG. 8 is the exemplary interface showing displaying a plurality of derivations corresponding to a selected predicate, according to an illustrative embodiment of the invention.

FIG. 9 is the exemplary interface showing displaying a derivation template corresponding to the selected derivation, according to an illustrative embodiment of the invention.

FIG. 10 is the exemplary interface showing an incorrect derivation input, according to an illustrative embodiment of the invention.

FIG. 11 is the exemplary interface showing explanation for the incorrect derivation input according to an illustrative embodiment of the invention.

FIG. 12 is the exemplary interface showing a correct derivation input, according to an illustrative embodiment of the invention.

FIG. 13 is the exemplary interface showing adding a resulting predicate to the plurality of known predicates, according to an illustrative embodiment of the invention.

FIG. 14 is the exemplary interface showing displaying a plurality of derivation input templates, according to an illustrative embodiment of the invention.

FIG. 15 is the exemplary interface showing displaying a hint for correcting incorrect derivation input.

FIG. 16 is an exemplary interface showing adding a predicate, according to an illustrative embodiment of the invention.

### DETAILED DESCRIPTION OF EMBODIMENTS OF THE INVENTION

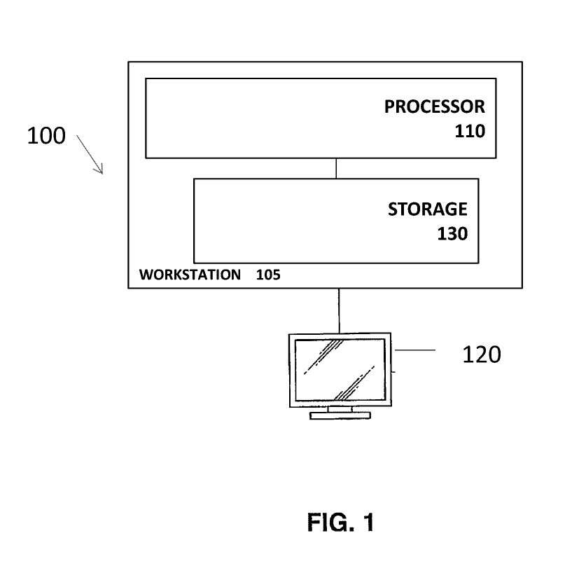

FIG. 1 is a diagram of an exemplary system 100 for assisting users in a geometric proof, according to an illustrative embodiment of the invention. The system 100 includes a display device 120 and a computer workstation 105. The workstation includes a storage 130 and a processor 110. During operation, a user can view and/or input data via the display device. The processor 110 can communicate with the storage 130 to retrieve data (e.g., theorem, geographical object, templates, derivations, and/or previous user input) to execute the methods according to the embodiments of the invention. The processing and/or storage can be performed on a server and transmitted to the display. The communication between the process, storage and/or display device can be wired or wireless. The processing and/or storage can be split up between any number of computing devices. It is apparent to one of ordinary skill in the art that the diagram shown here is for illustrative embodiments of the invention, and that other configurations are possible.

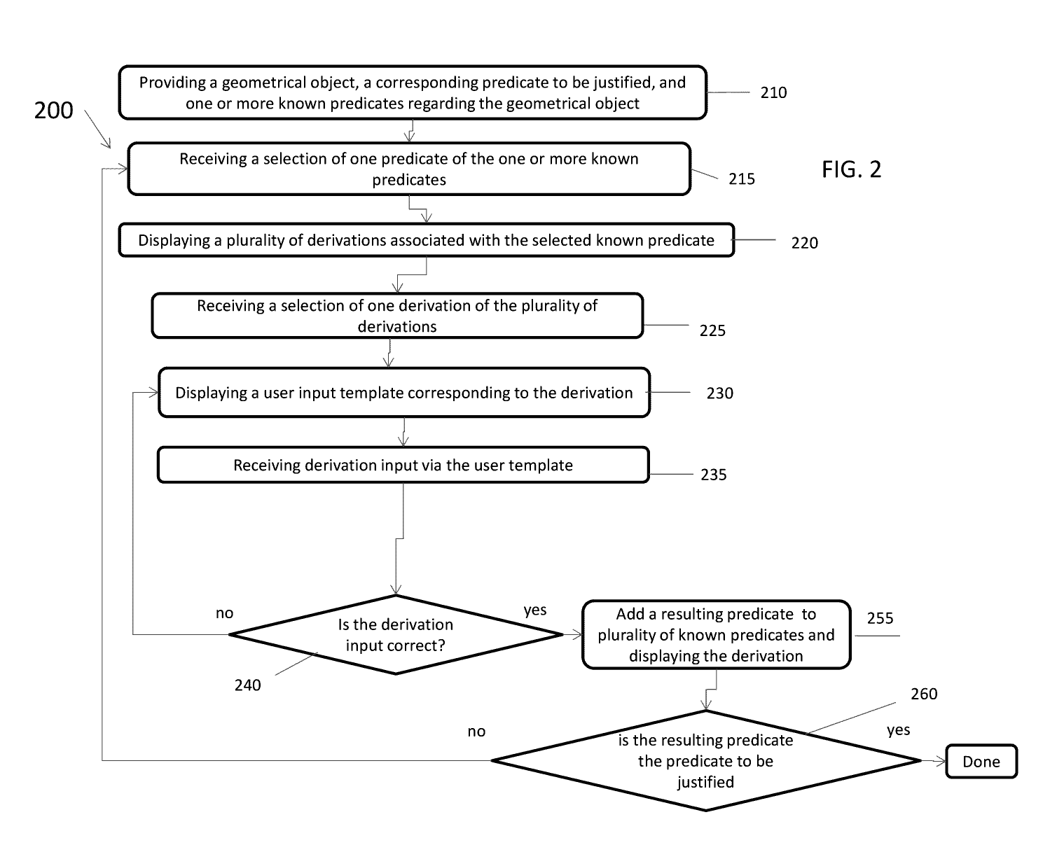

FIG. 2 is a flow diagram 200 illustrating a method for assisting users in a geometric proof, according to an illustrative embodiment of the invention. The method involves providing a geometrical object, a corresponding predicate to be justified (e.g., claim to be proved), and one or more known predicates regarding the geometrical object (Step 210). The geometrical object can be any geometrical object, for example a line, square, a triangle, a parallelogram, a hexagon, an octagon, a circle, a cylinder, a semicircle, or any combination thereof. In some embodiments, the geometrical object can be any geometrical object as is known in the art. Each geometrical object can include one or more predicates that are possible for the geometrical object based on principles of geometry. In some embodiments, the corresponding predicate to be justified can be specified as an input by the user. In some embodiments, the corresponding predicate to be justified can be randomly selected from all predicates that are possible for the geometrical object. In some embodiments, the corresponding predicate to be justified can be based on an age and/or school grade level of the problem solver (e.g., user).

In various embodiments, two or more predicates to be justified are displayed. In various embodiments, the predicate to be justified and/or the number of predicates to be justified is a configurable parameter. For example, the predicate to be justified and/or the number of predicates to be justified can be configured by an administrator, teacher, parent, student, and/or any combination thereof.

In some embodiments, the one or more known predicates are based on the geometrical object and/or the corresponding predicate to be justified. For example, assume a geometrical object of a parallelogram and a predicate to be justified that the two triangles within the parallelogram are equivalent. In this example, two known predicates can be presented to the user. First it is know that there is a parallelogram, and second, that there are two triangles.

The method also involves receiving a selection of one predicate of the one or more known predicates (Step 215). The selection can be input by a user via clicking on the desired predicate on the display, or any other user input mechanism as is known in the art.

The method also involves displaying a plurality of derivations (e.g., theorems) corresponding to the selected known predicate (Step 220). The plurality of derivations that correspond to the selected known predicate can be selected from all of the derivations that are known based on geometrical principals. The particular derivation of all of the derivations to include in the displayed plurality of derivations can be based on the predicate to be justified.

The method also involves receiving a selection of one derivation of the plurality of derivations (Step 225). The selection of the one derivation can be input by the user via clicking on the desired derivations that is on the display, or any other user input mechanism as is known in the art.

The method also involves displaying a user input template corresponding to the derivation (Step 230). The user input template can include input fields for each of term in the selected derivation. In some embodiments, none of the terms in the input fields are presented with values. In some embodiments, one or more of the terms in the input fields are populated with values.

The method also involves receiving derivation input via the user template (Step 235). The method also involves determining whether the derivation input is correct (Step 240). The determination can be based on geometrical principals, the geometrical object, known predicates, or any combination thereof.

If the derivation input is incorrect, then the method involves returning to Step 235 so that, for example, the user can input a different derivation input. In some embodiments, if the derivation input is incorrect, then an error indicator can be displayed. In some embodiments, a hint regarding the correct derivation input is displayed. In some embodiments,

If the derivation input is correct, then adding a resulting predicate to the plurality of known predicates and displaying the derivation input to the display (Step 255). The resulting predicate can be the output predicate from the derivation input and the derivation.

The method also involves determining whether the resulting predicate is the predicate to be justified (Step 260). If the resulting predicate input is not the predicate to be justified, then returning to Step 215. If the resulting predicate input is the predicate to be justified, then the method is done.

In some embodiments, a user can enter a second predicate to be justified. In these embodiments, the method starts at Step 220. In various embodiments, the user can enter any number of desired predicates to be justified.

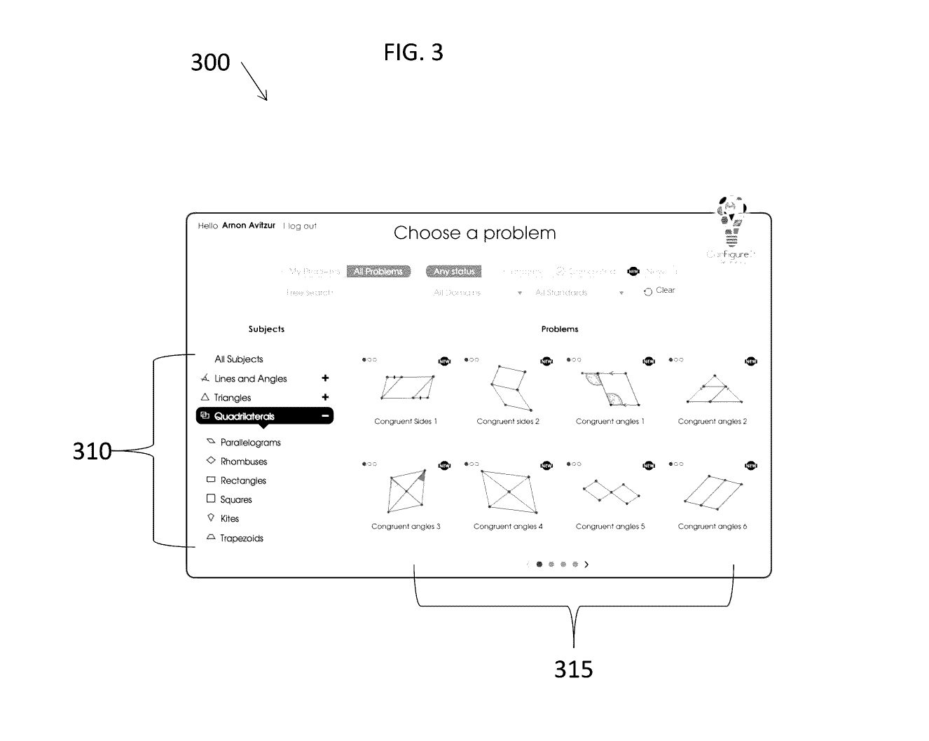

FIG. 3 is an exemplary interface 300 for displaying a geometrical problem, according to an illustrative embodiment of the invention. A plurality of geometrical categories 310 is displayed. Upon selection of one category of the plurality of geometrical categories 310, a plurality of corresponding geometrical objects 315 are displayed. Each of the geometrical objects 15 represents a problem to be solved. For example, in FIG. 3, the geometrical category of quadrilaterals is selected and the corresponding geometrical objects 315 are displayed.

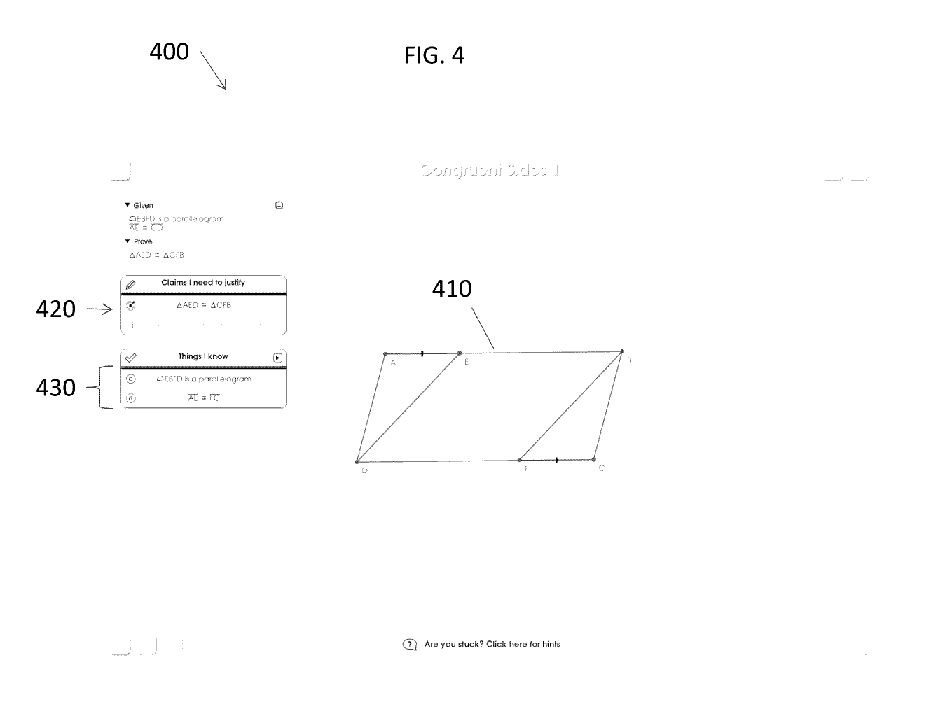

FIG. 4 is an exemplary interface 400 for providing a geometrical object 410, a predicate to be justified 420, and one or more known predicates 430, according to an illustrative embodiment of the invention. Upon selection by the user of the predicate to be justified 420 (e.g., claims I need to justify), or the one or more known predicates 430 (e.g., Things I know), a corresponding section on the geometrical object 410 can be highlighted.

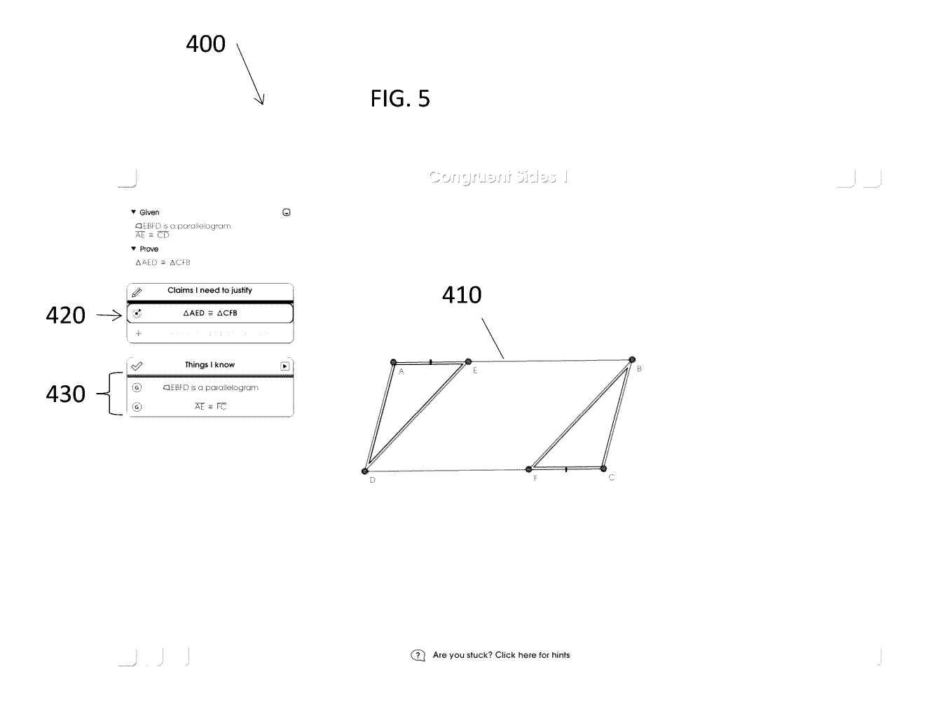

FIG. 5 is the exemplary interface 400 showing the predicate to be justified 420 highlighted on the geometrical object 410, according to an illustrative embodiment of the invention. As shown in FIG. 5, selecting the predicate to be justified ΔAED≅ΔCFB can result in the corresponding triangles on the geometrical object 410 highlighted.

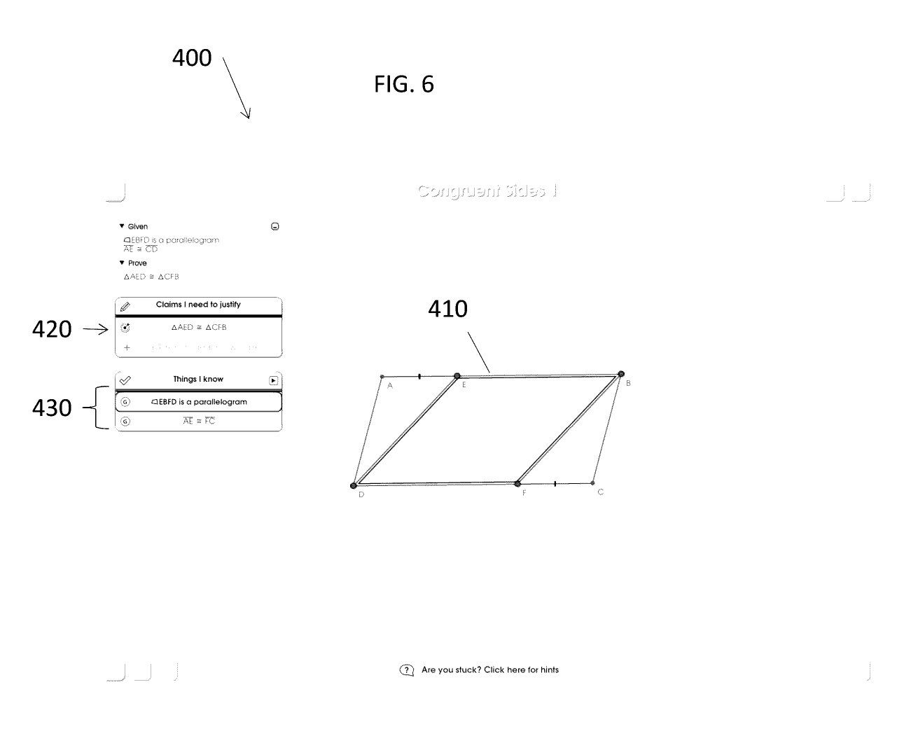

FIG. 6 is the exemplary interface 400 showing one predicate of the one or more known predicates 430 highlighted on the geometrical object 410, according to an illustrative embodiment of the invention. As shown in FIG. 6, selecting the known predicate “ABCD is a parallelogram” results in the corresponding parallelogram on the geometrical object 410 highlighted.

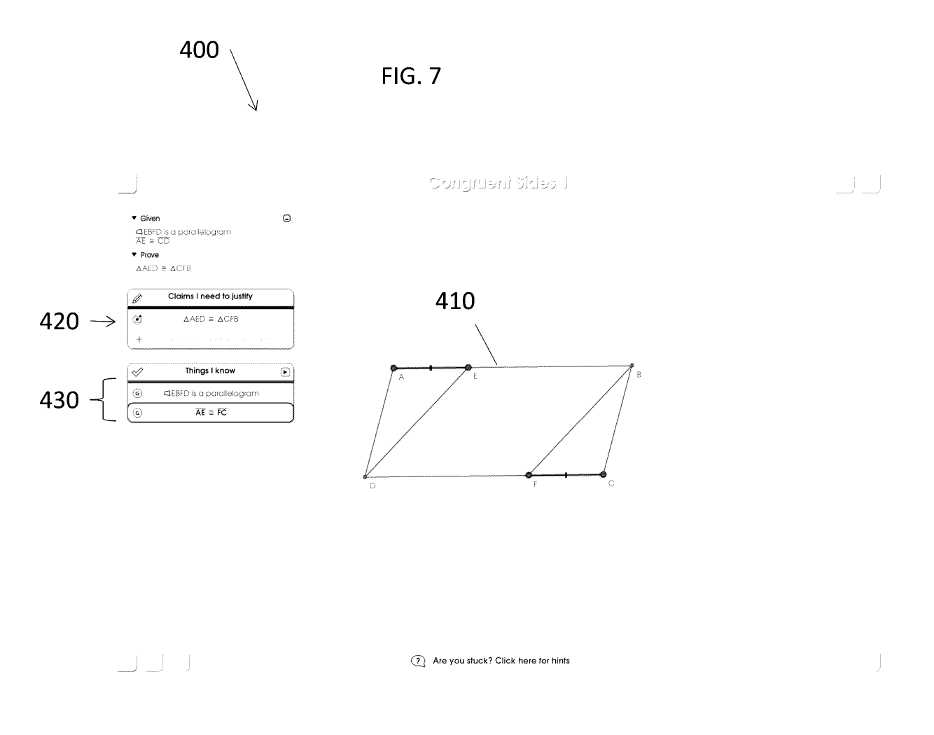

FIG. 7 is the exemplary interface 400 showing one known predicate of the one or more known predicates 430 highlighted on the geometrical object 410, according to an illustrative embodiment of the invention. As is shown in FIG. 7, selecting the known predicate A̅E̅≅F̅C̅ results in the lines AE and FC on the geometrical object 410 highlighted.

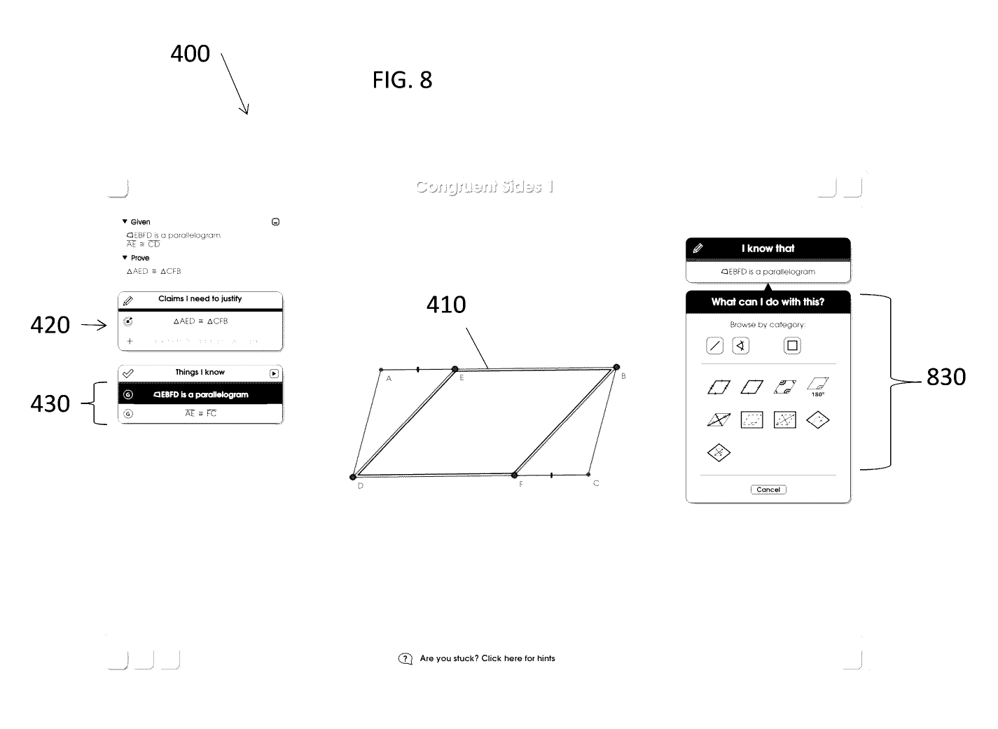

FIG. 8 is the exemplary interface 400 showing displaying a plurality of derivations 830 corresponding to the selected known predicate “ABCD is a parallelogram”, according to an illustrative embodiment of the invention. Each of the plurality of derivations 830 are derivations that correspond to the selected predicate. The plurality of derivations 830 can be grouped according to a derivations category. For example, derivations related to angles can be grouped and displayed together.

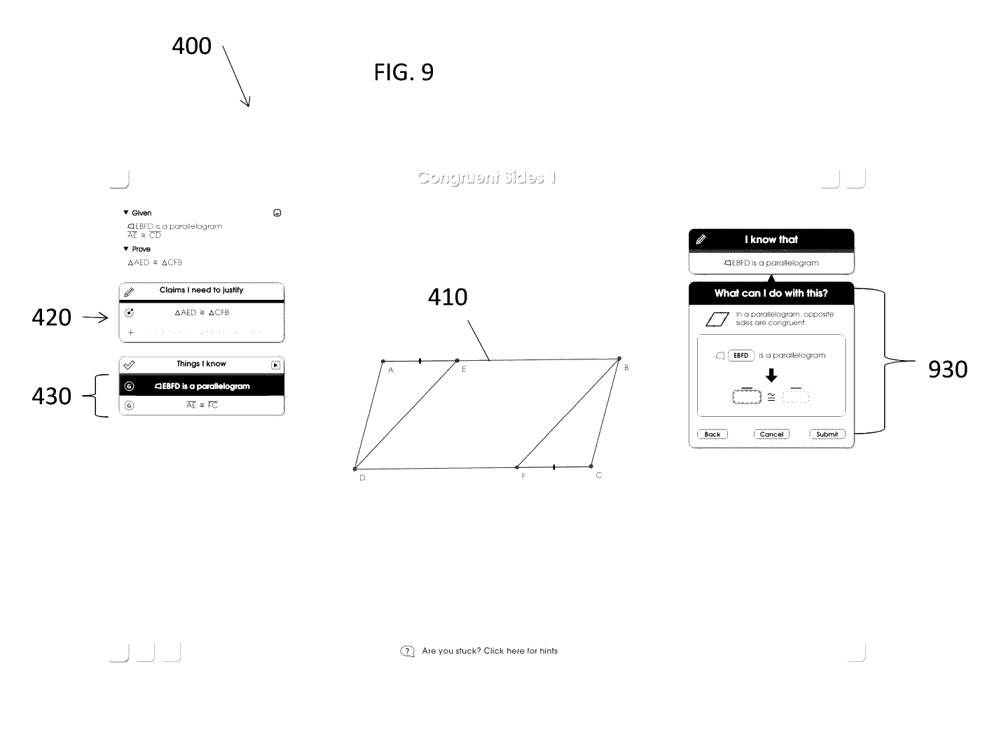

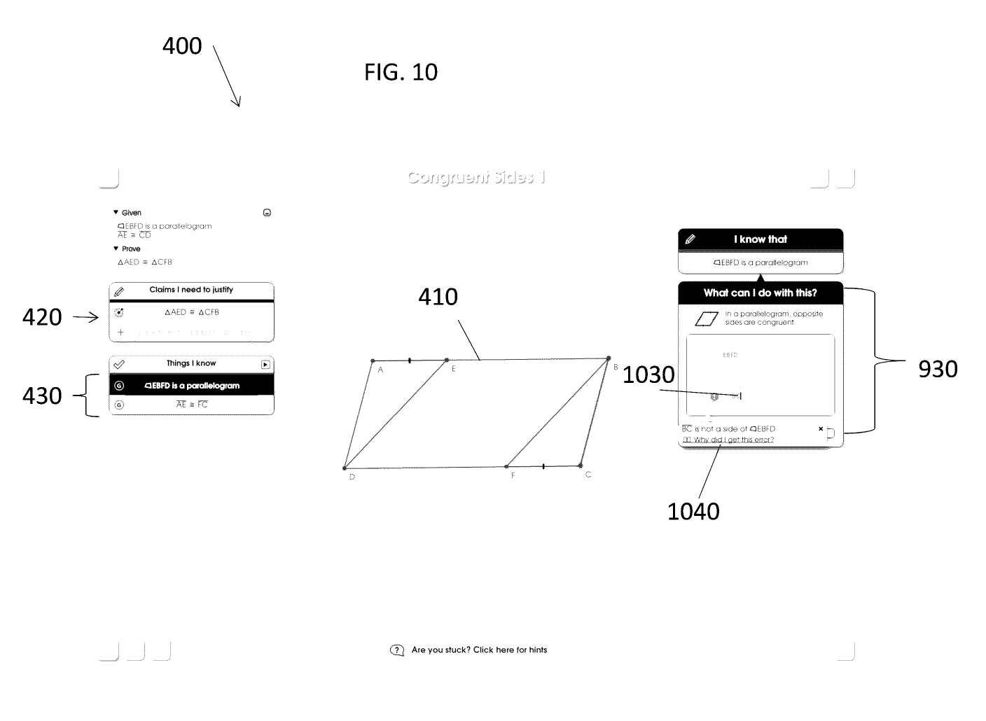

FIG. 9 is the exemplary interface 400 showing displaying a derivation template 930 corresponding to the selected derivation, according to an illustrative embodiment of the invention. As described above, upon selection of a derivation by the user, one or more derivations are selected, and a corresponding derivation template 930 is displayed to the user. The derivation template 930 has fields for the user to fill in. FIG. 10 is the exemplary interface 400 showing an incorrect derivation input indicator 1030 and reason for the error 1040, according to an illustrative embodiment of the invention.

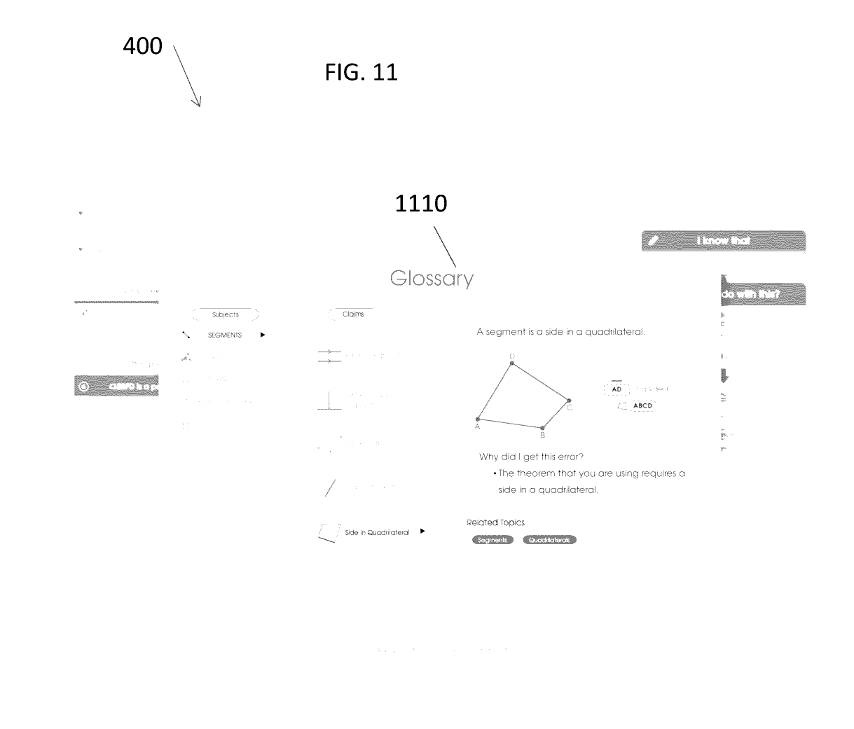

FIG. 11 is an exemplary interface 400 showing an explanation for the incorrect derivation input, according to an illustrative embodiment of the invention.

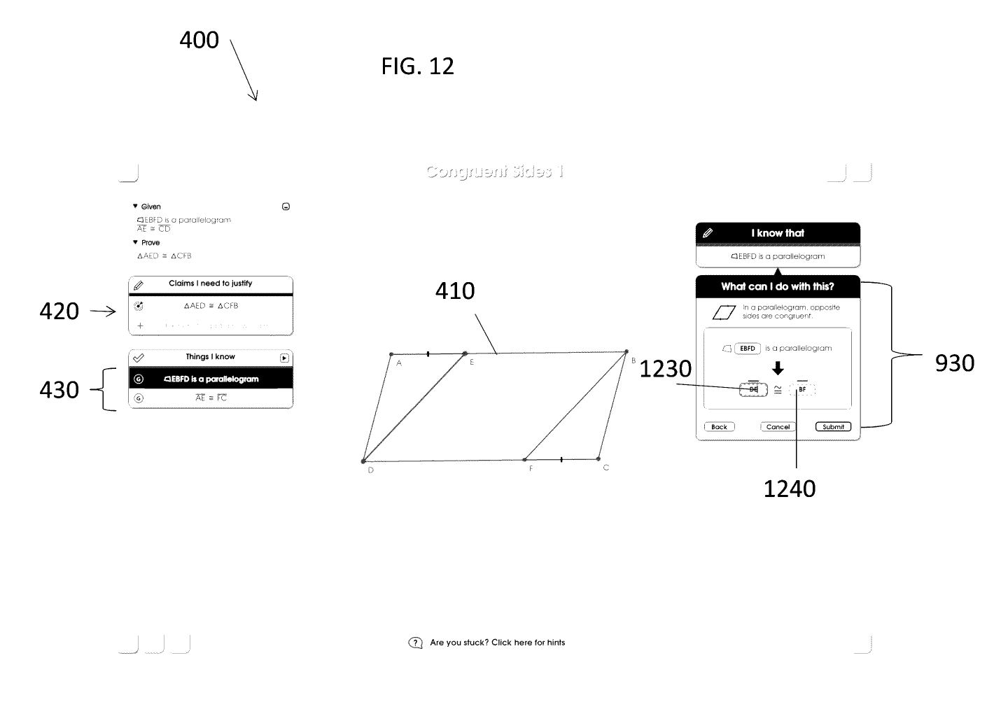

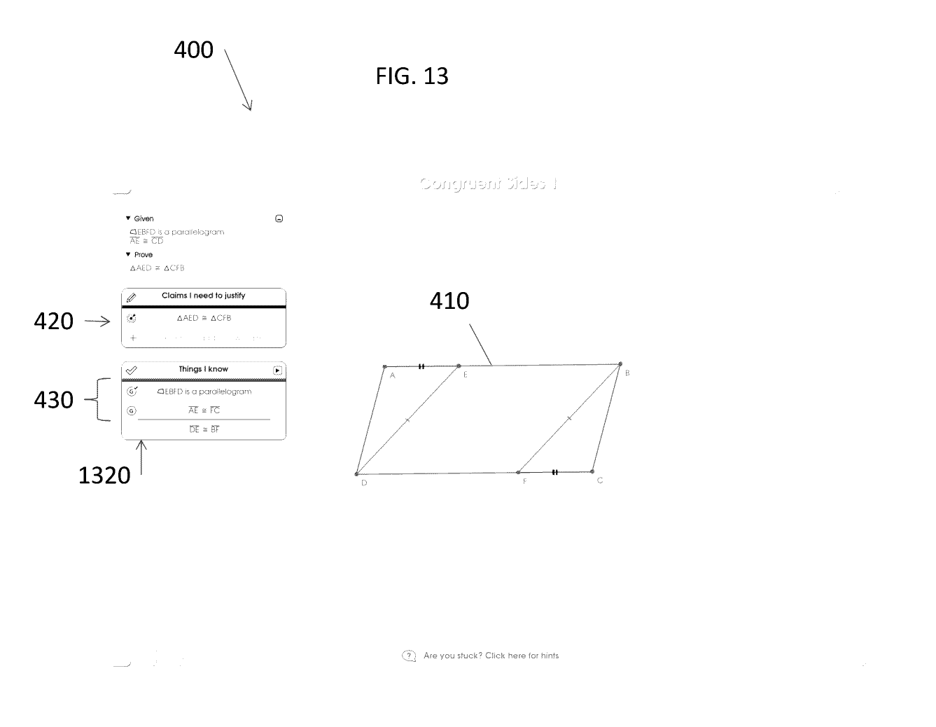

FIG. 12 is an exemplary interface 400 showing correct derivation inputs 1230 and 1240, according to an illustrative embodiment of the invention. As can be viewed in FIG. 13, when the user inputs the correct values, resulting predicate is added to the plurality of known predicates, according to an illustrative embodiment of the invention.

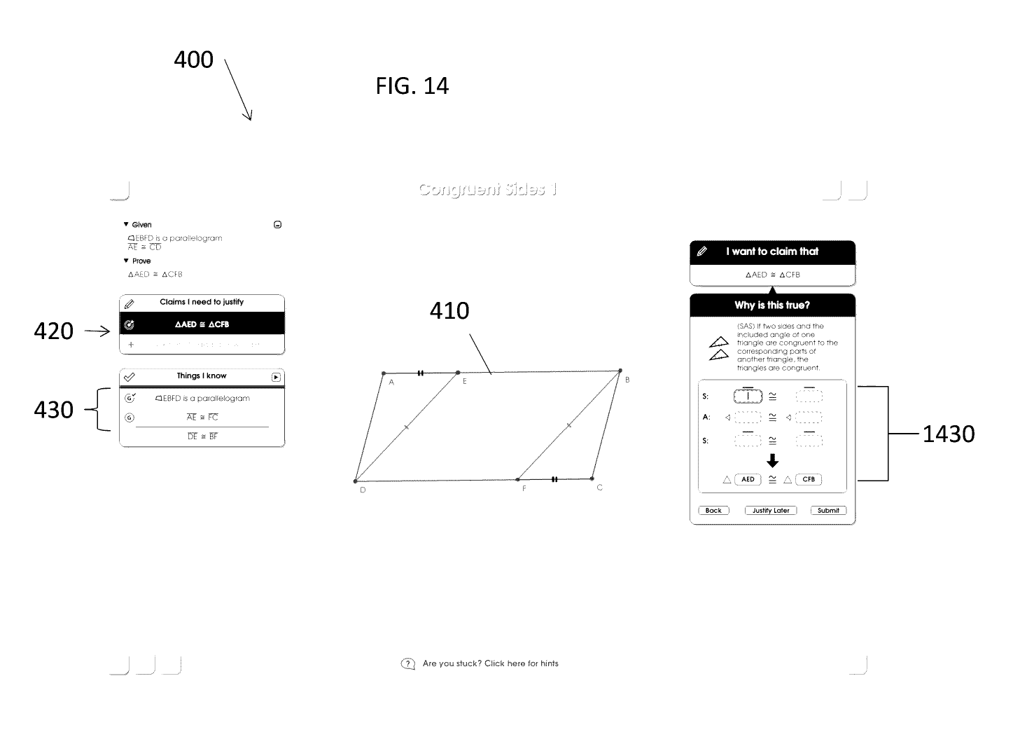

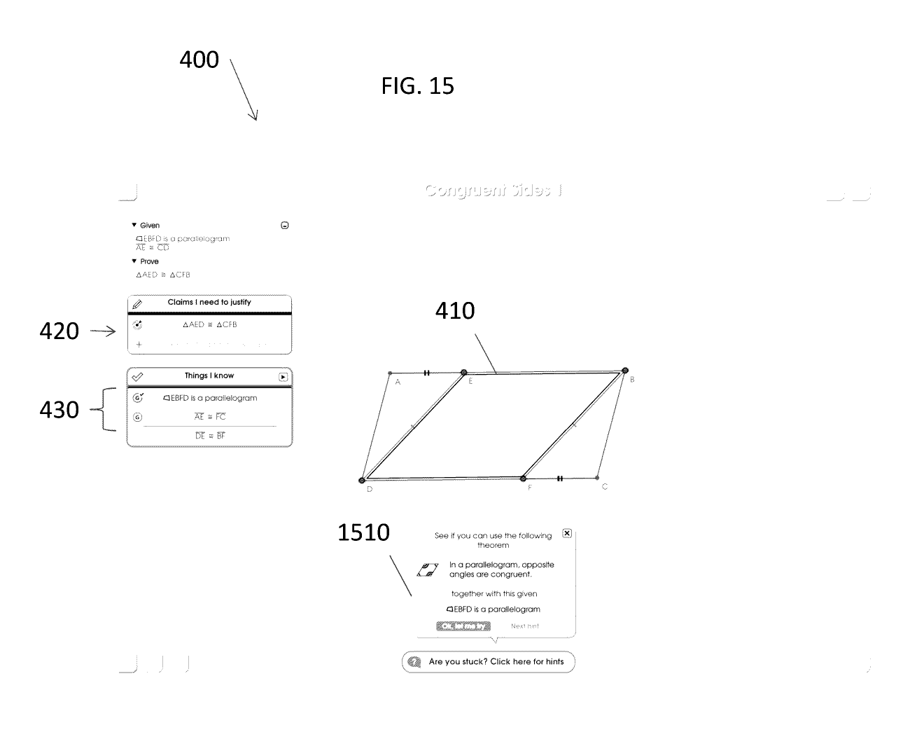

FIG. 14 is the exemplary interface 400 showing displaying a plurality of derivation templates 1430, according to an illustrative embodiment of the invention. FIG. 15 is the exemplary interface 400 showing displaying a hint 1510 for the justification, according to an illustrative embodiment of the invention.

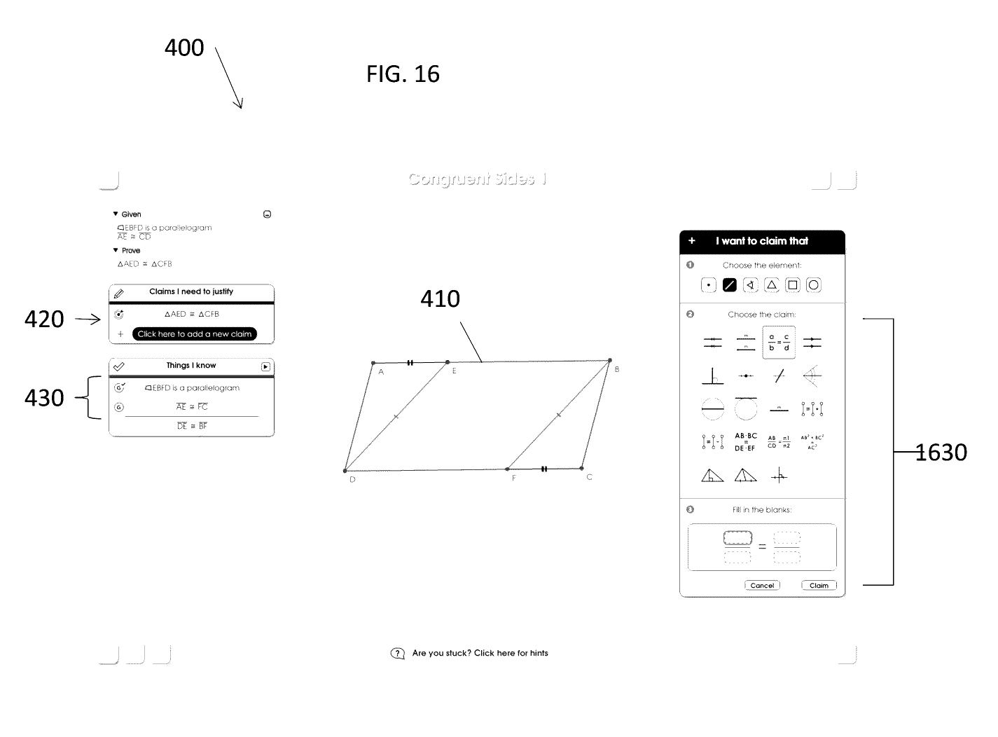

FIG. 16 is the exemplary interface showing adding a predicate, according to an illustrative embodiment of the invention.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A computerized-method for assisting a user in determining geometrical proofs, the computerized-method comprising:
a) providing, by a computing device, a geometrical object, a corresponding predicate to be justified, and one or more known predicates regarding the geometrical object;
b) receiving, by the computing device, a selection of one predicate of the one or more known predicates;
c) displaying, by the computing device, a plurality of derivations corresponding to the selected known predicate;
d) receiving, by the computing device, a selection of one derivation of the plurality of derivations;
e) displaying, by the computing device, a user input template corresponding to the derivation;
f) receiving, by the computing device, derivation input via the user template;
g) determining, by the computing device, whether the derivation input is correct;
h) if the derivation input is correct, then adding, by the computing device, a resulting predicate to the plurality of known predicates and transmitting the derivation input to the display;
i) determining, by the computing device, whether the resulting predicate is the predicate to be justified;
j) if the resulting predicate is not the predicate to be justified, then repeating steps b) through i).

2. The computerized-method of claim 1 further comprising if the derivation input is not correct transmitting an error indicator to the display.

3. The computerized-method of claim 3 further comprising displaying, by the computing-device, a hint for correcting the derivation input.

4. The computerized-method of claim 1 further comprising:
receiving, by the computing device, a second claim to be justified regarding the geometrical object; and
repeating steps b) though i).

5. The computerized-method of claim 1 wherein transmitting the derivation to the display further comprises transmitting a corresponding derivation description to the display.

6. The computerized-method of claim 1 wherein determining whether the derivation input is correct further comprises comparing the derivation input to the plurality of known predicates based on geometrical principals.

7. A non-transient computer readable medium containing program instructions to cause a computer to:
k) provide a geometrical object, a corresponding predicate to be justified, and one or more known predicates regarding the geometrical object;
l) receive a selection of one predicate of the one or more known predicates;
m) display a plurality of derivations corresponding to the selected known predicate;
n) receive a selection of one derivation of the plurality of derivations;
o) display a user input template corresponding to the derivation;
p) receive derivation input via the user template;
q) determine whether the derivation input is correct;
r) if the derivation input is correct, then add a resulting predicate to the plurality of known predicates and transmitting the derivation input to the display;
s) determine whether the resulting predicate is the predicate to be justified;
t) if the resulting predicate is not the predicate to be justified, then repeat steps b) through i).

8. The non-transient computer readable medium of claim 7, further causing the computer to: if the derivation input is not correct, transmit an error indicator to the display.

9. The non-transient computer readable medium of claim 7, further causing the computer to: display a hint for correcting the derivation input.

10. The non-transient computer readable medium of claim 7, further causing the computer to:
receive a second claim to be justified regarding the geometrical object; and
repeat steps b) though i).

11. The non-transient computer readable medium of claim 7, wherein transmitting the derivation to the display further causes the computer to transmit a corresponding derivation description to the display.

12. The non-transient computer readable medium of claim 7, wherein determining whether the derivation input is correct further causes the computer to: compare the derivation input to the plurality of known predicates based on geometrical principals.
